(19) United States
(12) Patent Application Publication
(10) Pub. No.: US 2008/0092541 A1
(43) Pub. Date: Apr. 24, 2008

(54) System for providing continuous electric power from solar energy

(75) Inventor: William Robert Palmer, Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/516,128

(22) Filed: Sep. 6, 2006

(51) Int. Cl. F03G 6/00; F03G 6/06

(52) U.S. Cl. 60/641.15; 60/641.8

(57) ABSTRACT

A system (112) for generating electric power from solar energy is provided. The system is comprised of a solar concentrator (302) formed of an optically reflective material having a curved surface. The curved surface defines a focal center toward which light incident on the curved surface is reflected. A PV/thermal device (310) is positioned substantially at the focal center. The PV/thermal device is comprised of a photovoltaic array (600) and a thermal energy collector (604). The thermal energy collector (604) is used as a fluid cooling system for the photovoltaic array. A thermal energy converter (116-1) is provided with a fluid coupling to the fluid cooling system. The thermal energy converter is configured for converting thermal energy from the fluid cooling system to electric power. A power generation system (128) is also provided. The power generation system is comprised of an electrolysis system that is coupled to the PV/thermal device and/or a combustor that is coupled to the electrolysis system and the thermal energy converter. The PV/thermal device, the thermal energy converter, and/or the power generation system provide electric power to a load.

### BACKGROUND OF THE INVENTION

1. Statement of the Technical Field

The invention concerns power systems, and more particularly, hybrid solar power systems that can convert solar energy into electric power.

2. Description of the Related Art

There are currently in use a wide variety of systems and methods for utilizing solar power as a source of energy. For example, photovoltaic systems are widely known for converting sunlight into electricity. Another common type of system is the solar trough. The solar trough is a type of solar thermal system where sunlight is concentrated by a curved reflector onto a pipe containing a working fluid that can be used for process heat or to produce electricity. Solar thermal electric power plants using solar trough technology are well known.

A variation of the solar trough technology is a photovoltaic concentrator system. The photovoltaic concentrator system uses sun-tracking mirrors that reflect light onto a receiver lined with photovoltaic solar cells. The mirrors concentrate the incident solar energy on the solar cells so that they are illuminated with approximately 25 times normal solar concentration. Such systems can convert at an efficiency of about 20%. The balance of the solar energy is converted into heat. However, the solar cells have an upper temperature limit of about 200° C. Accordingly, excess heat must be removed. Typically, this is accomplished by means of a cooled heat exchanger attached to the photovoltaic solar cells. For example, the photovoltaic cells can be provided with an integrated passive heat sink to maintain the solar cells at a moderate temperature

Despite the advantages offered by the foregoing systems, they still have not achieved a level of efficiency necessary for certain applications. For example, near space vehicles may be used in different applications, such as monitoring troops, surveillance of combatants, delivery of communications, and/or disaster area monitoring. Future near space vehicles are envisioned to travel between 60,000 feet to 80,000 feet above sea level. Consequently, near space vehicles will travel above the reach of conventional weapon systems and free from the threat of weather interference.

Current concept designs of long endurance near space vehicles are limited by their payload and propulsion capabilities. One limitation comes from a near space vehicle's dependency on fuel to power propulsion systems and onboard components, such as radars, sensors, imaging devices, control systems, and radio transmitters. A large amount of weight is invested to carrying a sufficient amount of fuel for flight. Consequently, the overall capabilities of a near space vehicle are limited.

Future near space vehicles are also envisioned to be powered by batteries. For example, a near space vehicle can utilize a lithium battery to power its propulsion systems and onboard components. The current designs of battery powered near space vehicles are also limited by their endurance capabilities. A near space vehicle's duration of flight is dependant on the energy density and life of the battery.

Despite the various power technologies known in the art there remains a need for a near space vehicle powered by a system that assures improved endurance capabilities. A near space vehicle design is also needed that is able to function twenty four hours a day, seven days a week (24/7), providing coverage of a strategic location on the earth to various users. In order to accomplish such a near space vehicle design, an integrated, flexible system is needed for remote power generation. A power system is also needed that can provide instantaneous power to electrical systems. A power system is further needed that is capable of converting solar energy to both thermal energy and electric energy efficiently in air temperatures (e.g., −60° F.) of near space altitudes (e.g., 60,000 feet above sea level). In order to convert 40% or more of the sun's incident energy into electric power, different architectures are required.

### SUMMARY OF THE INVENTION

The invention concerns a system for generating electric power from solar energy. According to one embodiment, the system includes a PV/thermal device. The PV/thermal device includes a photovoltaic array and a thermal energy collector. The thermal energy collector also forms part of a fluid cooling system for the photovoltaic array. A thermal energy converter is also provided. The thermal energy converter has one or more fluid couplings to the fluid cooling system and is configured for converting thermal energy from the fluid cooling system to electric power. A power generation system is also provided. The power generation system receives electric power generated by the photovoltaic array, the thermal energy converter or from both devices. The power generation system is configured to generate a fuel and an oxidizer. The fuel and the oxidizer are used in a combustor to heat the working fluid during hours when insufficient solar energy is available to do so. The heated working fluid is then used during a night cycle to drive the same or similar electric power system elements as utilized during the day cycle.

The invention makes use of a solar concentrator formed of an optically reflective material having a curved surface. A support means (such as, a support structure) is provided for the solar concentrator that includes one or more movable portions for varying a position of the solar concentrator. The curved surface of the solar concentrator defines a focal center (or a focal line) toward which light incident on the curved surface is reflected. The PV/thermal device is positioned substantially at the focal center (or along the focal line). A thermal interface is provided between the thermal energy collector and the photovoltaic array. The thermal interface defines a thermally conductive path for communicating heat from the photovoltaic array to the thermal energy collector. The thermal energy collector further includes one or more conduits containing a working fluid. During daylight hours, a fluid transport system continuously circulates the working fluid between the thermal energy converter and the thermal energy collector when the solar concentrator is exposed to solar radiation. The thermal energy converter includes an engine powered by the working fluid and can also include an electric generator powered (or rotated) by the engine.

According to one aspect of the invention, the solar concentrator, the PV/thermal device, the thermal energy converter, and the power generation system can be operatively disposed on a vehicle. If the system is based on a vehicle, the vehicle can advantageously include a lift system configured for carrying the vehicle to a near space altitude. Accordingly, the thermal energy converter can include one or more heat exchangers arranged for transferring heat from the working fluid to the very cold exterior atmosphere surrounding the vehicle. The vehicle can also include a control system programmed to control a position of the vehicle and an orientation of the solar concentrator described herein. Accordingly, the solar concentrator can be constantly pointed toward a source of solar radiation.

According to one aspect of the invention, the power generation system includes an electrolysis system configured for electrolyzing a hydrogen-oxygen mix into a fuel and an oxidizer. Two or more storage vessels are also provided for storing the fuel and the oxidizer. A combustor is configured for combusting the fuel and the oxidizer to produce a reaction product. A heat exchanger is provided and configured for transferring heat from the reaction product to a working fluid. The heated working fluid is then used during a night cycle to drive a thermal energy converter. Advantageously, the thermal energy converter can be the same thermal energy converter used to generate electric power during daylight hours.

A separate heat exchanger is advantageously provided for transferring heat from the reaction product to an ambient air for the purposes of regenerating the source from which the fuel and the oxidizer are formed. For example, if the reaction product is heated water vapor, then water vapor can be condensed and stored in a storage vessel so that the electrolysis process can be subsequently repeated.

According to an alternative embodiment, the invention includes a method for generating electric power from solar energy. The method begins by exposing to a source of solar radiation a PV/thermal device which includes a photovoltaic array. The photovoltaic array is cooled with a fluid cooling system comprised of a thermal energy collector (for example, a heat exchanger). The method continues by generating electric power with the photovoltaic array and with a thermal energy converter using thermal energy derived from the fluid cooling system. Finally, a portion of the electric power generated by the photovoltaic array and/or the thermal energy converter is provided to a power generation system. The power generation system uses the electric power to form a fuel and an oxidizer from a base product, such as water. The method also includes storing at least a portion of the fuel and the oxidizer that is generated during daylight hours when the system is operational. Subsequently, the fuel and the oxidizer thus formed are used to generate electricity during non-daylight hours.

According to one embodiment, the fuel and the oxidizer referred to herein can be hydrogen and oxygen, respectively. The fuel and the oxidizer can be combusted in a combustion process that generates a heated reaction product in the form of water vapor and heat. For example, the combusting step can include combusting a stoichiometric mixture derived from mixing the fuel and the oxidizer. Heat from the reaction product can be communicated to the one or more working fluids. Thereafter, the method continues by converting the thermal energy collected by the one or more working fluids to electric power. This can occur in a process similar to a Sterling cycle that includes powering an engine with the heated working fluid. This process can also include electric generation with the engine. For example, this process can include rotating an electric generator with the engine. This process can alternatively include using a linear generator for electric generation.

For the purpose of generating electricity from solar energy during daylight hours, the method includes exposing to a source of solar radiation a solar concentrator formed of an optically reflective material. The reflective material is selected to have a curved surface that defines a focal center (or the focal line) toward which light incident on the curved surface is reflected. The PV/thermal device is advantageously positioned substantially at the focal center (or along the focal line) of the PV/thermal device. Heat from the photovoltaic array is communicated to the thermal energy collector through a thermal interface. One or more working fluids contained within a fluid conduit of the thermal energy collector are heated in this way. Thereafter the heated working fluid is used to power an engine in a process similar to a Sterling cycle. The process also includes generating electricity by any suitable means, such as by powering (or rotating) an electric generator with the engine.

The foregoing process can be advantageously used to continuously provide electric power to a load, during periods of daylight and non-daylight hours. For example, the system can be installed on a vehicle, in which case the load can include the various onboard vehicle systems, including the propulsion system. If the vehicle is provided with a lift system, the process can advantageously include positioning the vehicle at a near space altitude (for example, 50,000 feet to 100,000 feet above sea level). Consequently, the power generating system can take advantage of a substantial temperature differential between the working fluid and a surrounding atmosphere at the near space altitude to power an engine. It should be appreciated that the ambient air at a near space altitude has a temperature of approximately negative sixty degrees Fahrenheit (−60° F.).

### BRIEF DESCRIPTION OF THE DRAWINGS

Embodiments will be described with reference to the following drawing figures, in which like numerals represent like items throughout the figures, and in which:

FIG. 1 is schematic illustration of a near space vehicle that is useful for understanding the invention.

FIG. 2 is a cross-sectional view of the near space vehicle of FIG. 1 taken along line 2-2.

FIG. 3 is a cross-sectional view of the near space vehicle of FIG. 1 taken along line 3-3.

FIG. 4 is a block diagram of a near space vehicle hardware architecture that is useful for understanding the invention.

FIG. 5 is a block diagram of a power system for a near space vehicle that is useful for understanding the invention.

FIG. 6 is an illustration that is useful for understanding the structure of a solar energy collector.

FIG. 7 is a cross-sectional view of the solar energy collector of FIG. 6 taken along line 7-7.

FIG. 8 is an illustration that is useful for understanding the structure of a solar energy collector array.

FIG. 9 is top view of a photovoltaic array and a thermal energy collector that is useful for understanding the invention.

FIG. 10 is a cross-sectional view of the photovoltaic array in FIG. 9 taken along line 10-10.

FIG. 11 is a schematic illustration of a thermal energy converter that is useful for understanding the invention.

FIG. 12 is a flow diagram illustrating a thermal energy conversion flow process that is useful for understanding the invention.

FIG. 13 is a flow diagram illustrating a thermal energy conversion flow process that is useful for understanding the invention.

FIG. 14 is a process flow diagram that is useful for understanding a method for powering a near space vehicle.

### DETAILED DESCRIPTION OF THE PREFERRED EMBODIMENTS

The invention concerns a system for generating electric power from solar energy. The system includes a solar energy collector that has a reflective surface. The reflective surface is a solar concentrator formed into a shaped surface for focusing solar radiation toward an elongated solar energy collection zone provided at a focal center (or along a focal line) defined by the reflective surface. An elongated PV/thermal device is positioned at the focal center (or along the focal line) within the solar energy collection zone. The PV/thermal device includes a photovoltaic array and a thermal energy collector. The photovoltaic array converts solar energy into electrical power. The thermal energy collector includes fluid conduits to provide passageways for the flow of a working fluid. The working fluid collects thermal energy as it flows through the thermal energy collector. The working fluid is used by a thermal energy converter to convert the thermal energy to electric power. In this regard, it should be appreciated that the working fluid goes through a thermal energy expansion process. The working fluid also provides an active and effective mechanism for cooling the photovoltaic cells. A portion of the electric power generated by the photovoltaic array and/or the thermal energy converter is supplied to a hydrogen-oxygen power generation system. The hydrogen-oxygen power generation system converts thermal energy into electric power. The foregoing arrangement results in a relatively simple system that converts solar energy to electric power with a high efficiency.

The power system described herein can be used to power any system, such as fixed and mobile systems used in terrestrial applications where there exists an available thermal sink (for example, a cold stream). However, the power system is especially advantageous for use in powering a vehicle intended for flight operations where there exists an available thermal sink (for example, a cold ambient air). For example, the present invention can be implemented in or on a near space vehicle. One significant advantage of using the system in a near space vehicle application is the large temperature differential that is achieved between the heated working fluid and the very cold atmosphere that exists at near space altitudes. Accordingly, the following discussion describes the present invention in the context of a near space vehicle application. Still, it should be understood that this description is merely presented as one possible arrangement, and the invention is not limited in this regard.

Near Space Vehicle

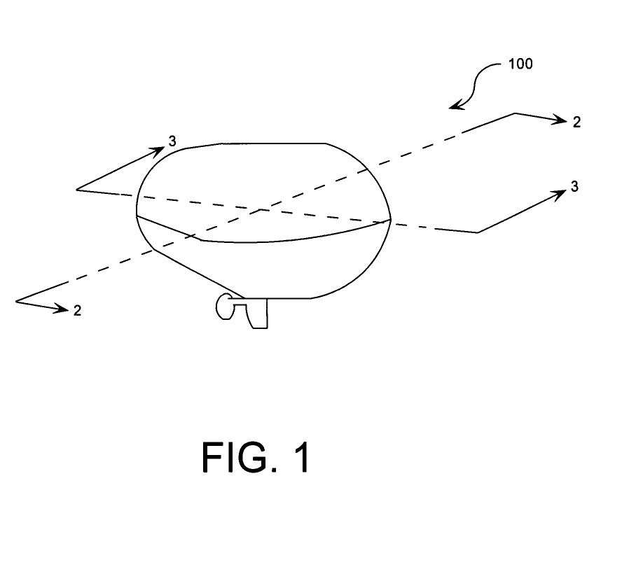

FIG. 1 is a schematic illustration of a near space vehicle 100 that is useful for understanding the invention. According to an embodiment of the invention, the near space vehicle 100 can be an unmanned, solar powered airship that can maintain a geostationary position at near space altitudes ranging between 50,000 feet to 100,000 feet above sea level. However, the invention is not limited in this regard and the system can be used in other types of vehicles.

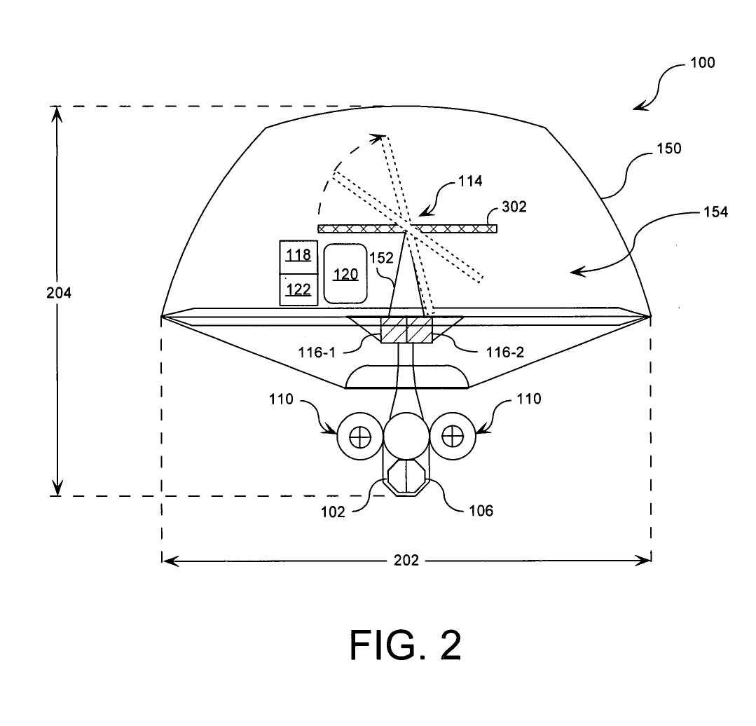

Referring now to FIG. 2, the near space vehicle 100 is comprised of a lift system 154 and a propulsion system 110. The near space vehicle 100 also includes a solar window 150, a solar energy collector 114, thermal energy converters 116-1, 116-2, a fluid storage device 120, an electrolysis system 118, and a combustor 122. The near space vehicle 100 can also include an imaging system 102 and a sensor system 106.

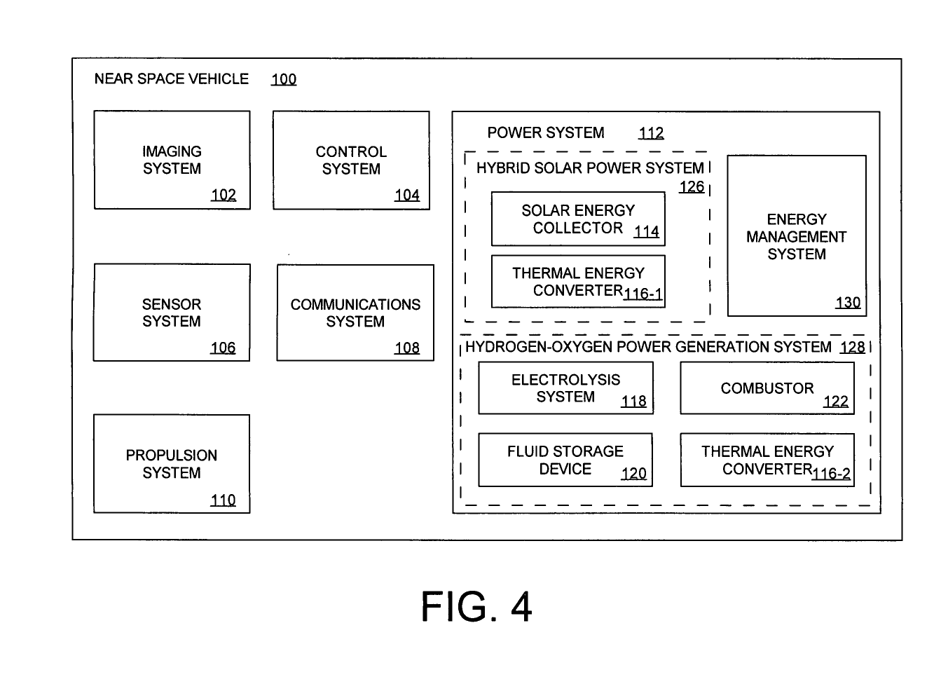

The lift system 154 provides lift to the near space vehicle 100. According to one embodiment of the invention, the lift system 154 is comprised of a lighter-than-air fluid (for example, helium or hydrogen) contained in an interior vessel defined by the near space vehicle 100. The propulsion system 110 controls the near space vehicle's direction of travel and can also control the vehicle's attitude (pitch, roll, and yaw). The propulsion system 110 is used for guiding a take off, guiding an ascent, guiding a decent, guiding a landing, and maintaining a geostationary position. For example, the propulsion system 110 can be used to maintain a position where the solar energy collector constantly faces the sun. The propulsion system 110 will be described in great detail below (in relation to FIG. 4).

The solar window 150 provides an optical path which is used to expose the solar energy collector 114 to a source of solar radiation (i.e. the sun). As such, the solar window 150 can be comprised of any optically transparent material suitable for operations at a near space altitude. Such materials can include transparent polymer films, glass, or plastic without limitation.

The solar energy collector 114 is coupled to the near space vehicle 100 by the support pedestal 152. The support pedestal 152 can be a light weight structure comprised of any material commonly used in the art, such as a metal, a metal alloy, a composite material, or a rigid polymer. The position of the solar energy collector 114 can be adjusted by or in conjunction with the support pedestal 152 such that a reflective surface 302 constantly faces the sun. For example, the support pedestal 152 can be designed with a movable portion that forms an adjustment mechanism. The adjustment mechanism can include electronics, sensors, pivot joints, and servo-motors such that the solar energy collector can be rotated and or pivoted about one or more axis. Such systems are well known in the art and can allow solar energy collector 114 to follow the movement of the sun.

According to another embodiment of the invention, an adjustment mechanism of the support pedestal 152 can be used to place the solar energy collector 114 in a sun pointing position. According to yet another embodiment of the invention, the propulsion system 110 in conjunction with an adjustment mechanism of the support pedestal 152 can be used to place the solar energy collector 114 in a sun pointing position.

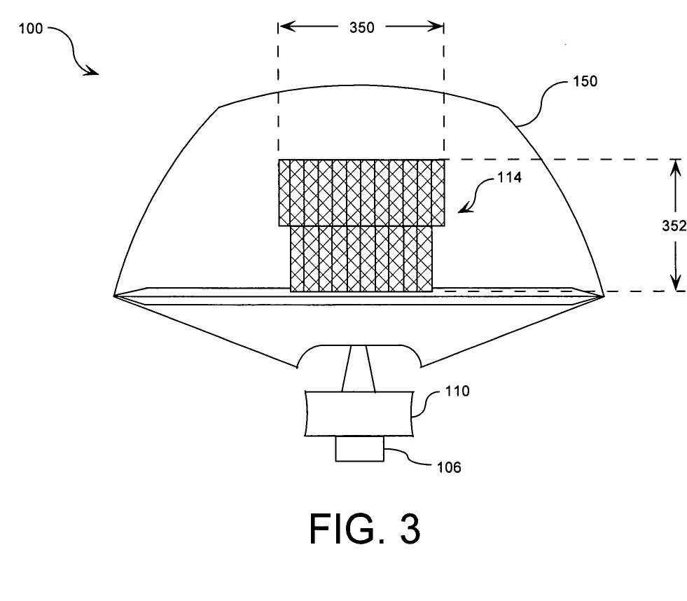

Referring now to FIG. 3, the solar energy collector 114 has a height 352 and a length 350. A person skilled in the art will appreciate that the height 352 and the length 350 can be selected in accordance with a solar energy collector 114 application. For example, a desired electric power output of the solar power system can dictate the sizing of the solar energy collector 114.

Referring again to FIG. 2, the near space vehicle 100 has a height 204, a length 202, and a width (not shown). A person skilled in the art will appreciate that the height 204, the length 202, and the width (not shown) can be selected in accordance with a near space vehicle 100 application. For example, the size of the vehicle can be selected so that the vehicle provides sufficient lift for the power system described herein and some predetermined payload. The payload can be selected in accordance with a near space vehicle application. A person skilled in the art will also appreciate that the structure of the near space vehicle 100 can be comprised of any material used in the art for high altitude balloons and airships, such as lightweight, high-strength fabrics, films, and composite materials.

Also, a person skilled in the art will appreciate that the near space vehicle 100 architecture is one embodiment of an architecture in which the methods described below can be implemented. However, the invention is not limited in this regard and any other suitable near space vehicle architecture can be used without limitation.

Near Space Vehicle Hardware Architecture

Referring now to FIG. 4, there is provided a block diagram of a near space vehicle 100 hardware architecture that is useful for understanding the invention. As shown in FIG. 4, the near space vehicle 100 includes a power system 112, a propulsion system 110, and a control system 104. The near space vehicle 100 can also include an imaging system 102, a sensor system 106, and a communications system 108. For example, the imaging system 102 can be comprised of a radar imaging system, a still camera, and/or a video camera for monitoring a strategic location on the earth. The control system 104 is advantageously comprised of one or more microprocessors programmed for controlling navigation of the near space vehicle 100 from a central location. The control system 104 can also be comprised of one or more microprocessors programmed for controlling the position of the near space vehicle 100 by controlling the operation of the propulsion system 110. The control system 104 can also be comprised of one or more microprocessors programmed for controlling an orientation of the solar energy collector 114. Such control can include controlling an adjustment mechanism of the support pedestal 152 such that the solar energy collector 114 constantly points towards a source of solar radiation.

The propulsion system 110 can include a motor that is powered by electricity. The communications system 108 can be comprised of an antenna element, a radio transceiver, and/or a radio receiver. The components of the communications system are well known to persons skilled in the art. Thus, the listed components will not be described in detail herein.

The power system 112 is comprised of a hybrid solar power system 126, a hydrogen-oxygen power generation system 128, and an energy management system 130. The hybrid solar power system 126 is comprised of the solar energy collector 114 and a thermal energy converter 116-1 for providing optimized solar energy conversion whereby directly converting photons to electrical power and supplying the same to the near space vehicle 100. The hybrid solar power system 126 converts solar energy into a sufficient amount of electric power to support the near space vehicle's 100 propulsion system 110 and/or electrical systems 102, 104, 106, 108. The hydrogen-oxygen power generation system 128 (also herein referred to as a power generation system) is comprised of an electrolysis system 118, a fluid storage device 120, a combustor 122, and a thermal energy converter 116-2. The hydrogen-oxygen power generation system 128 converts heat energy into a sufficient amount of electric power to support the near space vehicle's 100 propulsion system 110 and/or electrical systems 102, 104, 106, 108. According to one embodiment, the hybrid solar power system 126 in concert with the hydrogen-oxygen power generation system 128 can provide a continuous output of electric power twenty four (24) hours a day, seven (7) days a week, such that the near space vehicle can operate at a high altitude for an extended period of time (i.e., days, weeks, or months). The power system 112 will be described in further detail below.

A person skilled in the art will further appreciate that the near space vehicle 100 hardware architecture is one embodiment of a hardware architecture in which the apparatus and methods described below can be implemented. However, the invention is not limited in this regard and other suitable near space vehicle hardware architectures can be used without limitation. For example, a single thermal energy converter can be used in place of the thermal energy converters 116-1, 116-2.

System for Powering a Near Space Vehicle

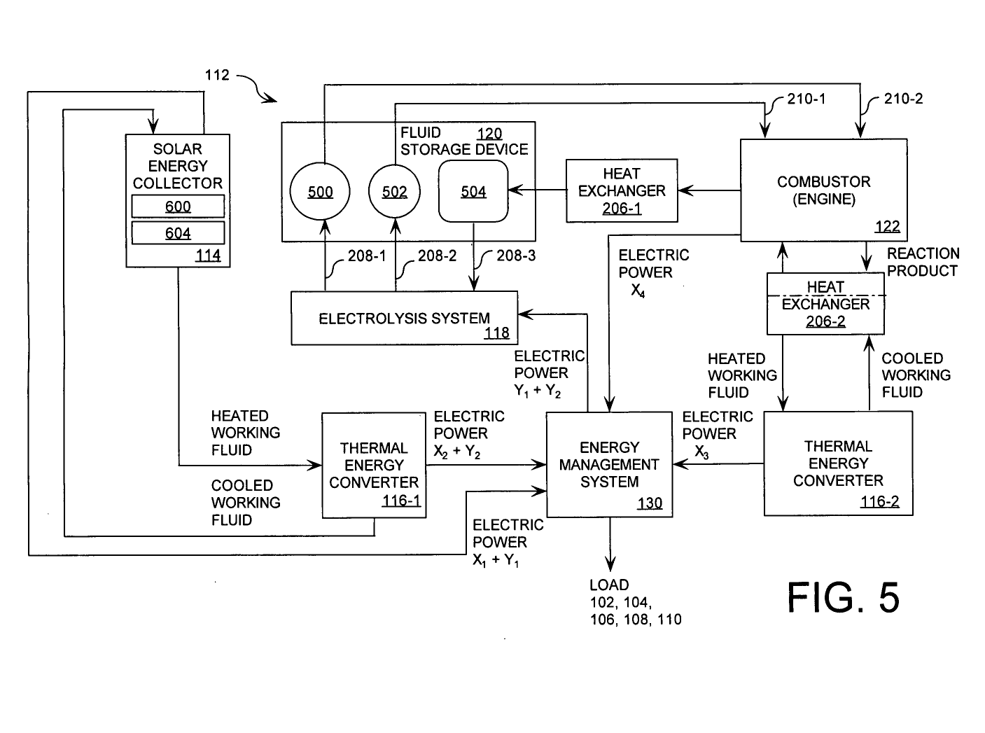

FIG. 5 is a block diagram of a power system that is useful for understanding the invention. As shown in FIG. 5, the power system 112 is comprised of a solar energy collector 114, thermal energy converters 116-1, 116-2, heat exchangers 206-1, 206-2, an electrolysis system 118, a fluid storage device 120, a combustor 122, and an energy management system 130. The solar energy collector 114, described in detail below, is electrically connected to the electrolysis system 118 and coupled to the thermal energy converter 116-1. The solar energy collector 114 is comprised of a photovoltaic array 600 that converts sunlight into electric power. The photovoltaic array 600 is electrically connected to the electrolysis system 118 through the energy management system 130. The photovoltaic array 600 can supply the electrolysis system 118 with all or a portion of its generated electric power. As shown in FIG. 5, the energy management system 130 is coupled to the electrolysis system 118 and can direct the electric power Y₁ generated by the photovoltaic array 500 to the electrolysis system 118 for electrolyzing a liquid (e.g., water H₂O) into a fuel (e.g., hydrogen H₂) and an oxidizer (e.g., oxygen O₂). In this regard, it should be appreciated that the electric power supplied by the photovoltaic array 500 to the electrolysis system 118 is controlled by the energy management system 130.

Similarly, the photovoltaic array 600 is electrically connected to the energy management system 130 and can supply all or a portion of its generated electric power to the energy management system 130 for powering the propulsion system 110 and/or the electrical systems 102, 104, 106, 108. In this regard, it should be appreciated that the energy management system 130 is part of an electrical power distribution system that includes one or more circuits configured for distributing electric power to one or more systems onboard the near space vehicle 100. For example, the energy management system 130 can direct power to the propulsion system 110 and/or electrical systems 102, 104, 106, 108. Energy management systems are well known to persons skilled in the art. Thus, energy management systems will not be described in detail herein.

The solar energy collector 114 is comprised of a thermal energy collector 604 including a working fluid which is used to cool the photovoltaic array 600. In this regard, it will be appreciated that the working fluid also collects thermal energy from solar radiation. The working fluid is circulated through the thermal energy collector 604 and the thermal energy converter 116-1. The working fluid is heated as it circulates through the thermal energy collector 604 and cools the photovoltaic array. The heated working fluid passes through the thermal energy converter 116-1 to generate electric power. One embodiment of the present invention uses a low vapor state liquid as the working fluid. In the thermal energy collector 604, a liquid working fluid is transformed into a gaseous working fluid by means of latent heat vaporization. The thermal energy converter 116-1 can supply the energy management system 130 with all or a portion of the electric power it generates.

It should be appreciated that the thermal energy converter 116-1 is coupled to the electrolysis system 118 through the energy management system 130. The thermal energy converter 116-1 can supply the electrolysis system 118 with all or a portion of the electric power it generates. As shown in FIG. 5, the energy management system 130 is coupled to the electrolysis system 118 and can direct the electric power Y₂ generated by the thermal energy converter 116-1 to the electrolysis system 118. In this regard, it should be appreciated that the electric power supplied by the thermal energy converter 116-1 to the electrolysis system 118 is controlled by the energy management system 130.

The electrolysis system 118 can electrolyze a liquid (e.g., water) into two or more gases (e.g., a hydrogen gas and an oxygen gas). For example, water (H₂O) can be chemically reduced into the constituent hydrogen (H₂) and oxygen (O₂) with added electricity:

H₂O+(e⁻)→H₂+0.5O₂

This process is called electrolysis. The thermal energy converter 116-1 and/or the photovoltaic array 600 can supply the required electrical power to the electrolysis system 118. Electrolysis systems are well known to persons skilled in the art. Thus, electrolysis systems will not be described in great detail herein.

The electrolysis system 118 is coupled to the fluid storage device 120. The fluid storage device 120 is comprised of a liquid vessel 504 for storing a liquid (e.g., water H₂O), a fuel vessel 500 for storing a fuel (e.g., hydrogen H₂), and an oxidizer vessel 502 for storing an oxidizer (e.g., oxygen O₂). A fluid transport system is disposed between the electrolysis system 118 and the fluid storage device 120. The fluid transport system is comprised of one or more fluid conduits 208-3 for communicating the liquid from the fluid storage device 120 to the electrolysis system 118. The fluid transport system is comprised of one or more fluid conduits 208-1, 208-2 for communicating the fuel and the oxidizer from the electrolysis system 118 to the fluid storage device 120.

The fluid storage device 120 is also coupled to the combustor 122. A fluid transport system is disposed between the fluid storage device 120 and the combustor 122. The fluid transport system is comprised of one or more fluid conduits 210-1, 210-2 for communicating the fuel and the oxidizer from the fluid storage device 120 to the combustor 122.

The combustor 122 can be a combustion engine, such as a constant pressure combustion engine, a constant volume combustion engine, or a catalytic combustor. The combustor 122 mixes the fuel and oxidizer to form a stoichiometric mixture (i.e., a fuel-to-oxidizer ratio that can result in a complete combustion). Thereafter, the combustor 122 burns the mixture to produce a reaction product (e.g., heated water vapor). Combustors 122 are well known to persons skilled in the art. Thus, combustors will not be described in detail herein. However, it should be appreciated that the combustor 122 can be used as an engine, such as a turbine engine or a piston engine having an electrical generator coupled thereto. In this regard, the combustor 122 is coupled to the energy management system 130 such that the combustor 122 can directly supply the energy management system 130 with all or a portion of the electric power X₄ that it generates.

As shown in FIG. 5, the combustor 122 is also coupled to the heat exchanger 206-1. The reaction product of combustor 122 is passed to the heat exchanger 206-1 such that the vaporous reaction product (e.g., water vapor) is cooled to become a liquid (e.g., liquid water H₂O). This cooling process is performed for the purposes of regenerating the source from which the fuel and the oxidizer are formed. The heat exchanger 206-1 takes advantage of the cold ambient air (e.g., −60° F.) for use as a coolant. This ambient cold air is in infinite supply at near space altitudes. After circulating through the heat exchanger 206-1, the liquid is communicated from the heat exchanger 206-1 to the liquid vessel 504 for storage. The stored liquid (e.g., liquid water H₂O) is used by the electrolysis system 118 to repeat the electrolysis process described above (i.e., generate a fuel and an oxidizer). In this regard, the electrolysis system 118, the combustor 122, the fluid storage device 120, and the heat exchanger 206-1 provide a closed loop system. Heat exchangers are well known to persons skilled in the art. Thus, heat exchangers will not be described in great detail herein.

The combustor 122 is also coupled to the heat exchanger 206-2. The reaction product of the combustion process described above flows across the exterior of the heat exchanger 206-2 such that thermal/heat energy is transferred from the reaction product to a working fluid circulating through the fluid conduits. The heated working fluid then passes to the thermal energy converter 116-2 to generate electric power. The thermal energy converter 116-2 can supply the energy management system 130 with all or a portion of the electric power it generates.

The power system 112 can be designed to support all of the power requirements of the near space vehicle 100. For example, a near space vehicle's propulsion system 110 and electrical systems 102, 104, 106, 108 can require X kilowatts (where, X=X₁+X₂+X₃+X₄) of electric power for operation. The electrolysis system 118 can require Y kilowatts (where, Y=Y₁+Y₂) of electric power to fully electrolyze a liquid into two or more gases during daylight hours. The photovoltaic array 600 can be designed to convert a sufficient amount of solar energy into Y₁+X₁ kilowatts of electric power. The thermal energy collector 604 can be designed to collect a sufficient amount of solar energy such that the thermal energy converter 116-1 outputs Y₂+X₂ kilowatts of electric power. A person skilled in the art will appreciate that the electric power generated by the photovoltaic array 600 and the thermal energy converter 116-1 can be managed in accordance with a near space vehicle application (i.e., all or a portion of the electric power generated from the photovoltaic array 600 and/or the thermal energy converter 116-1 can be supplied to the electrolysis system 118 and/or the energy management system 130).

The hydrogen-oxygen power generation system 128 can be designed such that the thermal energy converter 116-2 outputs X₃ kilowatts of electric power and/or the combustor 122 outputs X₄ kilowatts of electric power. A person skilled in the art will appreciate that the electric power generated by the thermal energy converter 116-2 and/or the combustor 122 can be managed in accordance with a near space vehicle application (i.e., all or a portion of the electric power generated from the thermal energy converter 116-2 and/or the combustor 122 can be supplied to the energy management system 130 for powering the various onboard systems during nighttime hours when solar radiation is not available. For example, the electric power generated during nighttime hours can be supplied to the propulsion system 110 and/or the electrical systems 102, 104, 106, 108).

According to an embodiment of the invention, the near space vehicle's propulsion system 110 and electrical systems 102, 104, 106, 108 require X kilowatts (where, X=X₁+X₂) for operation during a day cycle. In such a scenario, the thermal energy converter 116-2 and the combustor 122 do not output electric power. Accordingly, X₃ and X₄ equal zero kilowatts. However, the photovoltaic array 600 and the thermal energy converter 116-1 together generate a sufficient amount of electric power to support the propulsion system 110 and the electrical systems 102, 104, 106, 108 continuously throughout the day cycle.

According to another embodiment of the invention, the near space vehicle's propulsion system 110 and electrical systems 102, 104, 106, 108 require X kilowatts (where, X=X₃+X₄) for operation during a night cycle. In such a scenario, the photovoltaic array 600 and the thermal energy converter 116-1 do not output electric power. Accordingly, X₁ and X₂ equal zero kilowatts. However, the thermal energy converter 116-2 and/or the combustor 122 output a sufficient amount of electric power to support the propulsion system 110 and the electrical systems 102, 104, 106, 108 continuously throughout the night cycle.

A person skilled in the art will further appreciate that the power system 112 architecture is one embodiment of a power system architecture having a solar energy collector 114 in which the methods described below can be implemented. However, the invention is not limited in this regard and other suitable power system architectures can be used without limitation. For example, a single thermal energy converter can be used in place of the thermal energy converters 116-1, 116-2.

Hybrid Solar Energy Collector

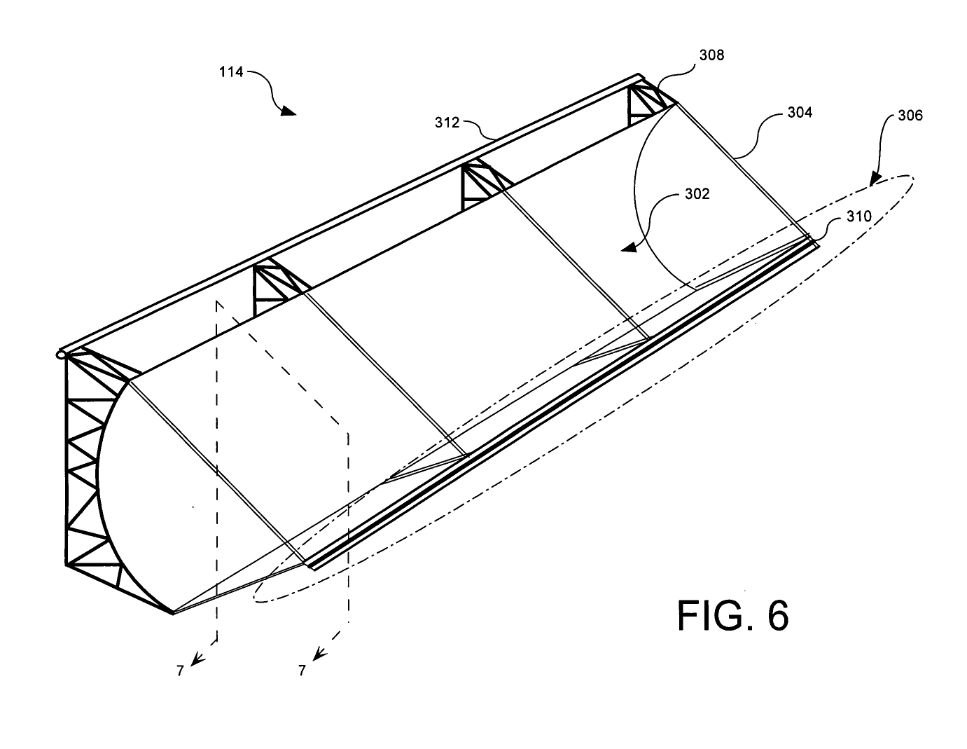

Referring now to FIG. 6, the solar energy collector 114 is comprised of a reflective surface 302 and a solar energy collection zone 306. The reflective surface 302 is a solar concentrator formed into a shaped surface for focusing solar radiation. The shaped surface can concentrate solar energy, at an intensity greater than its incident intensity, toward the solar energy collection zone 306 when the reflective surface is exposed to sunlight. In the embodiment shown in FIG. 6, the solar energy collection zone 306 is advantageously disposed substantially at a focal center (or along a focal line) of the reflective surface. According to one embodiment, the reflective surface 302 has a linear parabolic shape as shown in FIG. 6. However, the invention is not limited in this regard. Any other suitably shaped surface can be used for focusing solar energy toward the collection zone 306 provided that it has the ability to concentrate solar energy to a sufficient extent required for a particular application. The reflective surface 302 can be comprised of a reflective material commonly used in the art, such as a reflective film (e.g., aluminized film), mylar, or a silvered glass.

According to an embodiment of the invention, the reflective surface 302 is formed into a shape for concentrating solar radiation. For example, the reflective surface 302 can concentrate solar energy up to two hundred (200) times its incident intensity depending upon the arrangement of the reflective surface and the measured location within the collection zone 306 (i.e., have up to a 200:1 concentration ratio). Still, a person skilled in the art will appreciate that the invention is not limited in this regard. The concentration ratio can be selected in accordance with a solar energy collector 114 application.

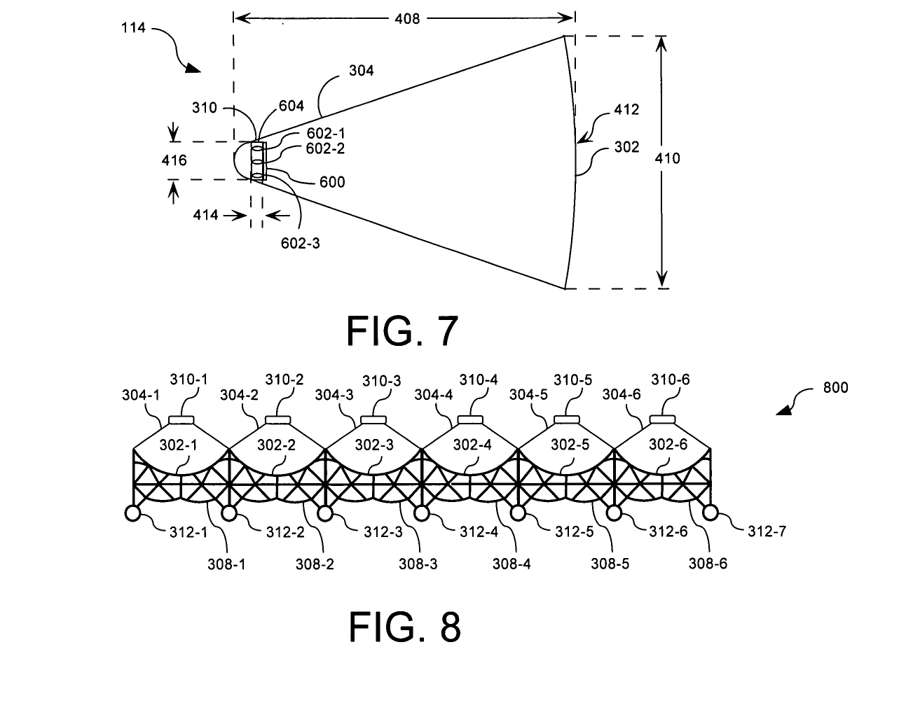

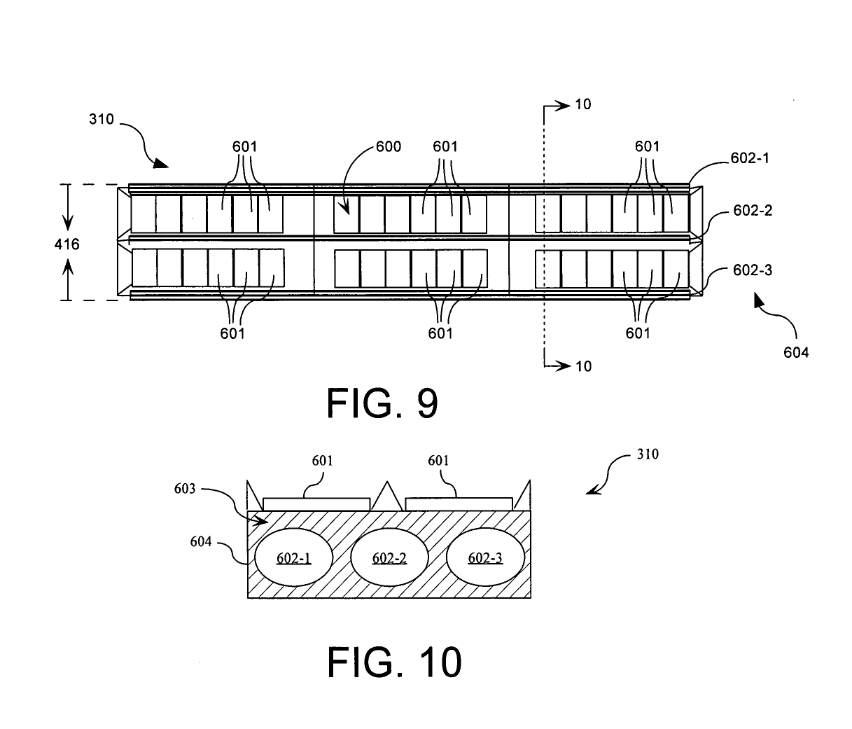

The photovoltaic array 600 and the thermal energy collector 604 (collectively, PV/thermal device 310) will now be described in greater detail with respect to FIG. 7, FIG. 8, and FIG. 9. The PV/thermal device 310 is fixed in a position at the focal center (or the focal line) of the shaped reflective surface 302. For example, the PV/thermal device 310 can be maintained in this position by means of a rigid frame 304. Those skilled in the art will appreciate that only a portion of the PV/thermal device 310 can be positioned precisely on the focal center (or the focal line) of the reflective surface 302 so as to receive a highest concentration of solar energy. Those portions of the PV/thermal device 310 which are positioned away from this focal center (or the focal line) will receive a somewhat lower concentration of solar energy. Consequently, the concentration ratio of thermal energy can vary somewhat. For example, the concentration ratio for an embodiment of the invention can vary between about 20:1 to 50:1 over the surface of the PV/thermal device 310. Notably, a shaped surface having a focal center (or the focal line) can advantageously provide a sufficient amount of heat at the PV/thermal device 310 to create a large temperature differential between the PV/thermal device 310 and the near space atmosphere.

The rigid frame 304 can be made from any suitable material, such as a metal, a metal alloy, a composite, a fiber reinforced plastic, or a polymer material. The rigid frame 304 is coupled to a support structure 308. The support structure 308 can be attached to the truss tube 312. The support structure 308 is also coupled to a support pedestal 152 of the near space vehicle 100, such that the reflective surface 302 can face the sun during daylight hours.

Referring now to FIG. 7, a cross-sectional view of the solar energy collector 114 is provided. The solar energy collector 114 has a width 408. The reflective surface 302 has a height 410. The reflective surface 302 is comprised of a curved surface having a curvature 412. The PV/thermal device 310 has a height 414 and a width 416. The Width 408, 416, the height 410, 414, and the curvature 412 can be selected in accordance with a solar energy collector 114 application. For example, a desired electric power output of the hybrid solar power system 126 can dictate the sizing of the reflective surface 302 and the PV/thermal device 310. As shown in FIG. 7, the PV/thermal device 310 is comprised of a thermal energy collector 604 and a photovoltaic array 600. The thermal energy collector 604 is comprised of one or more fluid conduits 602-1, 602-2, 602-3 to provide passageways for the flow of a working fluid.

Referring now to FIG. 8, it will be appreciated that instead of using just one solar energy collector 114, two or more such solar energy collectors 114 can be arranged in rows and/or columns to form an array 800. The array 800 can be comprised of support structures 308-1, 308-2, 308-3, 308-4, 308-5, and 308-6. The support structures can be attached to truss tubes 312-1, 312-2, 312-3, 312-4, 312-5, 312-6, and 312-7. The support structures can support reflective surfaces 302-1, 302-2, 302-3, 302-4, 302-5, and 302-6. Further, a set of rigid frames 304-1, 304-2, 304-3, 304-4, 304-5, 304-6 attached to the support structures can be used to position a plurality of PV/thermal devices 310-1, 310-2, 310-3, 310-4, 310-5, 310-6.

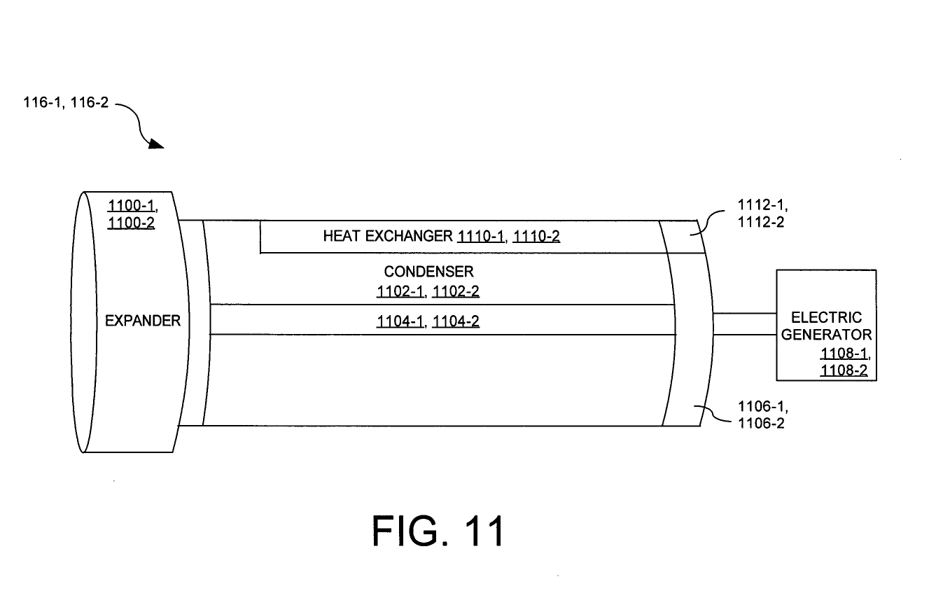

Although it can be advantageous to focus incident light toward a solar energy collection zone, it will be appreciated that excessive amounts of heat can damage the photovoltaic array. Accordingly, it can be advantageous to provide a cooling mechanism for the photovoltaic array. Referring now to FIG. 9, a top view of the PV/thermal device 310 is provided. FIG. 10 is a cross-sectional view of the PV/thermal device 310 taken along line 10-10. Referring to FIG. 9, it can be observed that the thermal energy collector 604 is comprised of one or more fluid conduits 602-1, 602-2, 602-3 to provide passageways for the flow of a working fluid. The fluid conduits can be arranged in a linear path or can follow a serpentine path through the thermal energy collector to maximize heat transfer. A thermal interface 603 is disposed between the fluid conduits 602-1, 602-2, 602-3 and the solar cells 601 that form the solar array. The thermal interface 603 can be comprised of any suitable material that provides efficient thermal conduction of heat from the solar cells 601 to the fluid contained in the fluid conduits.

The flow of the working fluid through the one or more fluid conduits 602-1, 602-2, 602-3 can be produced by compressing the fluid before it enters the fluid conduits 602-1, 602-2, 602-3. As the working fluid is heated by solar energy, it can change from a liquid state to a gaseous state. Alternatively, mechanical means (e.g., a circulating pump or a fan) can be used to create flow of the working fluid through fluid conduits 602-1, 602-2, 602-3. The fluid conduits 602-1, 602-2, 602-3 can be comprised of any material that is a good thermal conductor capable of constraining the fluid.

The photovoltaic array 600 can substantially cover a surface of the PV/thermal device 310 exposed to sunlight from reflective surface 302. The fluid conduits 602-1, 602-2, 602-3 and the photovoltaic array 600 are positioned such that the photovoltaic array 600 can be cooled by a working fluid circulating through the passageways. For example, the photovoltaic array 600 can be arranged in one or more rows running parallel and adjacent to fluid conduits 602-1, 602-2, 602-3. The thermal interface 603 can be provided between the photovoltaic array 600 and the fluid conduits 602-1, 602-2, 602-3 to provide a path for transferring thermal energy directly from photovoltaic array 600 to thermal energy collector 604.

Photovoltaic cells 601 typically include a base material, such as silicon, copper indium diselenide, or cadmium telluride. The base material can be a mono-crystalline base material, a multi-crystalline base material, or an amorphous base material. Photovoltaic cells 601 are often thin wafers having a base material and/or other nonmetallic elements, such as boron. Photovoltaic cell's 601 front surface is often composed of a metallic grid for enabling an electrical connection to an external device. Similarly, photovoltaic cell's 601 back surface can be composed of a metallic material, coextensive with its surface area, for enabling an electrical connection to an external device.

According to an embodiment of the invention, photovoltaic array 600 is selected to include one or more high efficiency photovoltaic cells. For example, the photovoltaic cells 601 have an efficiency of about twenty eight (28) percent. Still, a person skilled in the art will appreciate that the invention is not limited in this regard. Photovoltaic array 600 can be selected to include photovoltaic cells 601 in accordance with a particular PV/thermal device 310 application.

A person skilled in the art will further appreciate that the hybrid solar energy collector 114 architecture of FIG. 6, FIG. 7, FIG. 8, and FIG. 9 is one embodiment of a hybrid solar energy collector in which the methods described below can be implemented. However, the invention is not limited in this regard and other suitable hybrid solar energy collector architectures having a photovoltaic array and a thermal energy collector can be used without limitation.

Thermal Energy Converter and Thermal Energy Flow Process

FIG. 11 is a schematic illustration of a thermal energy converter according to an embodiment of the invention. Thermal energy converters 116-1, 116-2 are engines comprised of an expander 1100-1, 1100-2, a condenser 1102-1, 1102-2, a shaft 1104-1, 1104-2, compressors 1106-1, 1106-2 and 1112-1, 1112-2, a heat exchanger 1110-1, 1110-2, and an electric generator 1108-1, 1108-2, respectively. The expander 1100-1, 1100-2, driven by a flow of a working fluid, is coupled to shaft 1104-1, 1104-2 such that the expander 1100-1, 1100-2 rotates shaft 1104-1, 1104-2. The expander 1100-1, 1100-2 can be a type of expander capable of extracting work from the flow of the working fluid (e.g., a steam engine). Shaft 1104-1, 1104-2 drives electric generator 1108-1, 1108-2 to produce electric power from mechanical energy. Condenser 1102-1, 1102-2 converts a working fluid from a gas to a liquid (i.e., removes heat from the working fluid). Condenser 1102-1, 1102-2 is comprised of a heat exchanger 1110-1, 1110-2 configured for transferring thermal energy from a portion of the working fluid circulating through heat exchanger 1110-1, 1110-2 to a cold ambient air (e.g., −60° F.) flowing across its outer surface. Notably, this ambient air is essentially in infinite supply at near space altitudes (e.g., 60,000 feet above sea level). Compressor 1112-1, 1112-2 compresses the working fluid after circulating through heat exchanger 1110-1, 1110-2. Compressor 1106-1, 1106-2 compresses the working fluid to reduce its volume.

According to an embodiment of the invention, thermal energy converters 116-1, 116-2 are advantageously selected to produce electric power at a high efficiency rate. For example, using current technology the thermal energy converters 116-1, 116-2 can be designed to reasonably achieve a very high power conversion efficiency (such as, approximately fifty (50) percent). Still, a person skilled in the art will appreciate that the invention is not limited in this regard. The thermal energy converters 116-1, 116-2 can produce electric power at an efficiency rate consistent with available current technology that is in accordance with a particular power system 112 application.

A person skilled in the art will appreciate that the thermal energy converter 116-1, 116-2 architecture is one embodiment of a thermal energy converter architecture in which the methods described below can be implemented. However, the invention is not limited in this regard and other suitable thermal energy converter architectures can be used without limitation, provided that it operates with a relatively high degree of efficiency. Also, it should be appreciated that a single thermal energy converter can be used in place of thermal energy converters 116-1, 116-2.

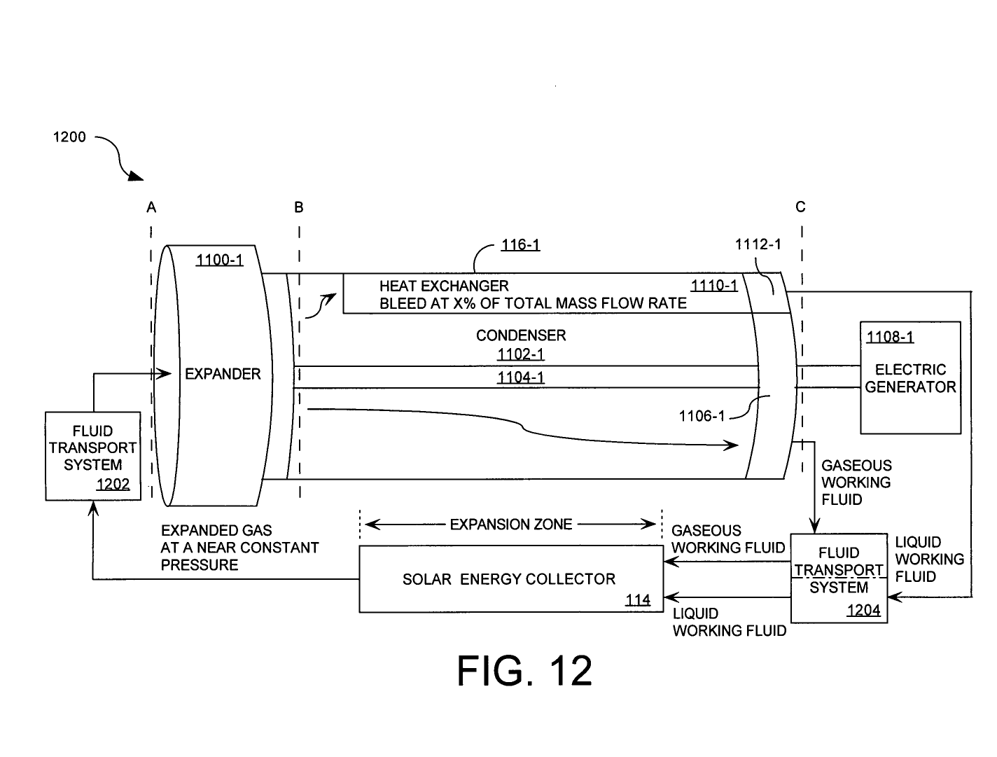

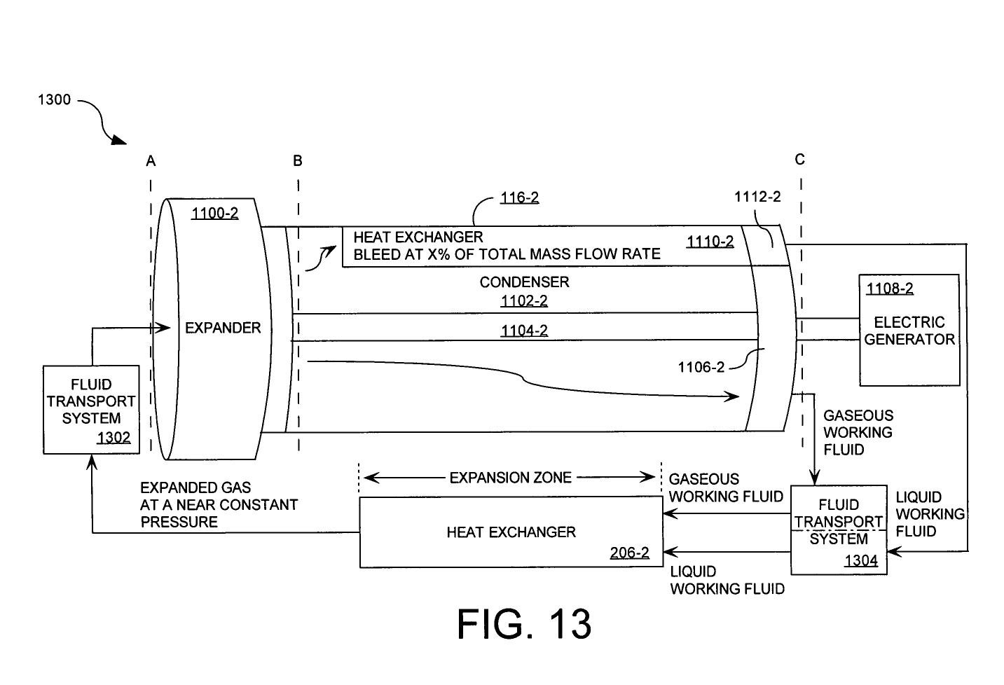

Referring now to FIG. 12 and FIG. 13, a thermal energy conversion flow process 1200, 1300 is provided that utilizes the thermal energy converters 116-1, 116-2 in a heat transfer cycle (for example, a Stirling cycle) for the conversion of thermal/heat energy into electric power. A Stirling cycle is well known and involves heating a working fluid to increase its pressure and create a fluid motive drive pressure. The pressurized working fluid flows through the expander 1100-1, 1100-2 to create work. Subsequently, the working fluid is cooled to decrease its pressure and create a constant fluid flow through the expander 1100-1, 1100-2.

Referring to FIG. 12, there is illustrated a thermal energy conversion flow process 1200 which includes the thermal energy converter 116-1. The process begins when a working fluid circulates under pressure through the solar energy collector 114. As the pressurized working fluid circulates through the solar energy collector 114, thermal energy is transferred to the working fluid. This transfer of thermal energy causes a change in the state of the working fluid from a liquid state to a gaseous state which results in the expansion of the working fluid. After changing state, the working fluid flows towards the fluid transport system 1202. The fluid transport system 1202 (for example, a pipeline) communicates the pressurized working fluid from the solar energy collector 114 to the thermal energy converter 116-1. The working fluid enters the thermal energy converter 116-1 at point A where the motive drive pressure equals P1. As the gaseous working fluid flows through the thermal energy converter 116-1, the expander 1100-1 is driven by the large volumetric flow of the pressurized working fluid such that it rotates the shaft 1104-1. The shaft 1104-1 drives the electrical generator 1108-1 to produce electric power. After flowing through the expander 1100-1, a portion of the gaseous working fluid continues to flow to the condenser 1102-1. This gaseous working fluid then flows to compressor 1106-1 where its volume can be reduced. The working fluid exits the compressor 1106-1 at point C where the motive drive pressure equals a value that is slightly higher than P1. Subsequently, the pressurized working fluid flows into a fluid transport system 1204 (for example, a pipeline for a gaseous working fluid). The fluid transport system 1204 communicates the gaseous working fluid from the compressor 1106-1 to the solar energy collector 114 where the gaseous working fluid mixes with a liquid working fluid.

The remaining portion of the gaseous working fluid flows into the heat exchanger 1110-1 which uses the ambient air as a coolant. The heat exchanger 1110-1 is configured to transfer (i.e., bleed) thermal energy from a portion of the gaseous working fluid at X % of the gaseous working fluids mass flow rate. This process results in a pressure drop from point A to point B, i.e., the motive drive pressure at point A equals P1 and the motive drive pressure at point B equals P2 where P2 is equal to P1−X % bleed. It should be understood that the bleed of the working fluid is the portion of the gaseous working fluid allowed to be condensed to a liquid working fluid. The pressure drop between point A and point B contributes to the constant fluid flow through the expander 1100-1. The liquid working fluid then flows to the compressor 1112-1 where its volume is reduced. The liquid working fluid exits the compressor 1112-1 at point C where the motive drive pressure equals a value that is slightly higher than P1. Subsequently, the pressurized working fluid flows into a fluid transport system 1204 (e.g., a pipeline for a liquid working fluid). The fluid transport system 1204 communicates the liquid working fluid from the compressor 1112-1 to the solar energy collector 114 where the liquid working fluid mixes with the gaseous working fluid and where the liquid working fluid changes from a liquid state to a gaseous state.

A person skilled in the art will further appreciate that the thermal energy conversion flow process 1100 is one embodiment of the invention. However, the invention is not limited in this regard and any other suitable thermal energy converter flow process can be used without limitation to generate electricity. Specifically, it should be appreciated that any heat transfer cycle can be used with the present invention. In this regard, any Stirling cycle can also be used with the present invention.

Referring to FIG. 13, there is shown a thermal energy conversion flow process 1300 that includes the thermal energy converter 116-2. The process begins when a working fluid circulates under pressure through the heat exchanger 206-2. As the pressurized working fluid circulates through the heat exchanger 206-2, thermal/heat energy is transferred to the working fluid. This transfer of thermal energy causes a change in the state of the working fluid from a liquid state to a gaseous state which results in the expansion of the working fluid. After changing state, the working fluid flows towards the fluid transport system 1302. The fluid transport system 1302 (for example, a pipeline) communicates the pressurized working fluid from the heat exchanger 206-2 to the thermal energy converter 116-2. The working fluid enters the thermal energy converter 116-2 at point A where the motive drive pressure equals P1. As the gaseous working fluid flows through the thermal energy converter 116-2, the expander 1100-2 is driven by the large volumetric flow of the pressurized working fluid such that it rotates the shaft 1104-2. The shaft 1104-2 drives the electrical generator 1108-2 to produce electric power. After flowing through the expander 1100-2, a portion of the gaseous working fluid continues to flow to condenser 1102-2. This gaseous working fluid then flows to the compressor 1106-2 where its volume can be reduced. The working fluid exits the compressor 1106-2 at point C where the motive drive pressure equals a value that is slightly higher than P1. Subsequently, the pressurized working fluid flows into a fluid transport system 1304 (for example, a pipeline for a gaseous working fluid). The fluid transport system 1304 communicates the gaseous working fluid from the compressor 1106-2 the heat exchanger 206-2.

The remaining portion of the gaseous working fluid flows into the heat exchanger 1110-2 which uses the ambient air as a coolant. The heat exchanger 1110-2 is configured to transfer (i.e., bleed) thermal energy from the working fluid at X % of the fluids mass flow rate. This process results in a pressure drop from point A to point B, i.e., the motive drive pressure at point A equals P1 and the motive drive pressure at point B equals P2 where P2 is equal to P1−X % bleed. It should be understood that the bleed of the working fluid is the portion of the gaseous working fluid allowed to be condensed to a liquid working fluid. The pressure drop between point A and point B contributes to the constant fluid flow through the expander 1100-2. The liquid working fluid then flows to the compressor 1112-2 where its volume can be reduced. The working fluid exits the compressor 1112-2 at point C where the motive drive pressure equals a value that is slightly higher than P1. Subsequently, the pressurized working fluid flows into a fluid transport system 1304 (for example, a pipeline for a liquid working fluid). The fluid transport system 1304 communicates the liquid working fluid from the compressor 1112-2 to the heat exchanger 206-2 where the liquid working fluid mixes with gaseous working fluid and where the liquid working fluid changes from a liquid state to a gaseous state.

A person skilled in the art will further appreciate that the thermal energy conversion flow process 1300 is one embodiment of the invention. However, the invention is not limited in this regard and any other suitable thermal energy converter flow process can be used without limitation to generate electricity. Specifically, it should be appreciated that any heat transfer cycle can be used with the present invention. In this regard, any Stirling cycle can also be used with the present invention.

According to an embodiment of the invention, the working fluid used in flow processes 1200, 1300 is selected to include a low vapor state working fluid. For example, the working fluid can be comprised of propane C₃H₈, ammonia NH₃, and butane C₄H₁₀. The working fluid can also be selected as a hydrocarbon. Still, a person skilled in the art will appreciate that the invention is not limited in this regard. Working fluid can be selected in accordance with the thermal gradient between the solar energy collector 114 and the heat exchanger 1110-1, 1110-2.

Method for Powering a Near Space Vehicle

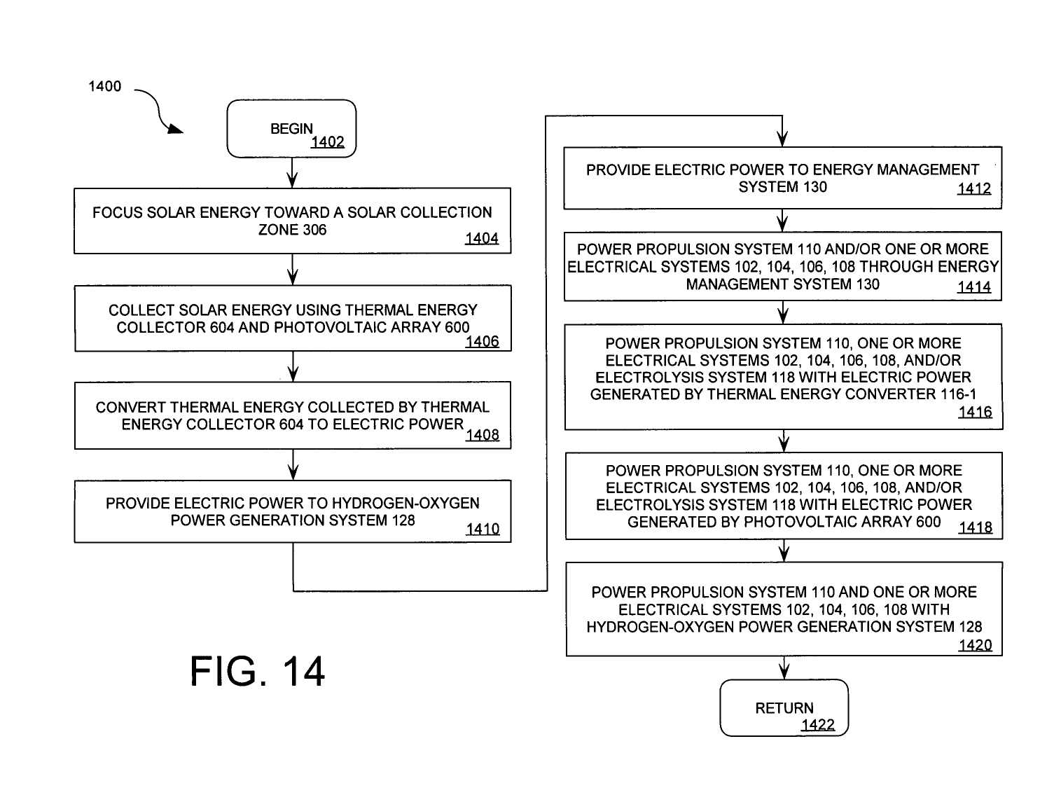

FIG. 14 is a process flow diagram illustrating a method for powering a near space vehicle using power system 112 of FIG. 4 and FIG. 5. Method 1400 begins with step 1402 and continues with step 1404. In step 1404, solar energy is focused towards a solar collection zone 306. In step 1406, solar energy is collected using thermal energy collector 604 and a photovoltaic array 600. It will be appreciated that this step also cools photovoltaic array. The solar energy collected by thermal energy collector 604 is converted into electric power in step 1408. This step involves transferring thermal energy from thermal energy collector 604 to a working fluid. The working fluid is transported from thermal energy collector 604 to a thermal energy converter 116-1 for conversion of thermal energy into electric power. After converting thermal energy into electric power, control is passed to step 1410. In step 1410, electric power is provided to hydrogen-oxygen power generation system 128. Also, electric power is provided to energy management system 130 in step 1412. After providing electric power to energy management system 130, method 1400 continues with step 1414 where electric power is supplied to propulsion system 110 and/or one or more electrical systems 102, 104, 106, 108 through energy management system 130. Subsequently, control is passed to step 1416 where propulsion system 110, one or more electrical systems 102, 104, 106, 108, and/or electrolysis system 118 are powered with the electric power generated by thermal energy converter 116-1. Propulsion system 110, one or more electrical systems 102, 104, 106, 108, and/or electrolysis system 118 are also powered with the electric power generated by photovoltaic array 600. Propulsion system 110, one or more electrical systems 102, 104, 106, 108, and/or electrolysis system 118 is further powered with hydrogen-oxygen power generation system 128. After supplying power to the near space vehicles 100 systems 110, 102, 104, 106, 108, 118, step 1420 is performed where method 1400 returns to step 1402.

A person skilled in the art will appreciate that method 1400 is one embodiment of a method for powering a near space vehicle 100 using a hybrid solar power system 126 and a hydrogen-oxygen power generation system 128. However, the invention is not limited in this regard and any other suitable method for powering a near space vehicle using a hybrid solar power device and a hydrogen-oxygen power generation system can be used without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A system for generating electric power from solar energy, comprising:
a PV/thermal device comprising a photovoltaic array and a thermal energy collector comprising a fluid cooling system for said photovoltaic array;
a thermal energy converter having at least one fluid coupling to said fluid cooling system, and configured for converting thermal energy from said fluid cooling system to electric power; and
a power generation system provided with electric power generated by at least one of said photovoltaic array and said thermal energy converter, said power generation system configured for generating a fuel and an oxidizer.

2. The system according to claim 1, further comprising a solar concentrator formed of an optically reflective material having a curved surface, said curved surface defining a focal center or a focal line toward which light incident on said curved surface is reflected; and wherein said PV/thermal device is positioned substantially at said focal center or along said focal line.

3. The system according to claim 2, further comprising a thermal interface between said thermal energy collector and said photovoltaic array, said thermal interface defining a thermally conductive path for communicating heat from said photovoltaic array to said thermal energy collector.

4. The system according to claim 3, wherein said thermal energy collector further comprises at least one conduit containing a working fluid.

5. The system according to claim 4, wherein said at least one fluid coupling further comprises a fluid transport system for continuously circulating said working fluid between said thermal energy converter and said thermal energy collector when said solar concentrator is exposed to solar radiation.

6. The system according to claim 5, wherein said thermal energy converter further comprises an engine powered by said working fluid.

7. The system according to claim 6, wherein said thermal energy converter further comprises an electric generator powered by said engine.

8. The system according to claim 2, further comprising a support means for said solar concentrator, said support means comprising at least one movable portion for varying a position of said solar concentrator.

9. The system according to claim 2, wherein said solar concentrator, said PV/thermal device, said thermal energy converter, and said power generation system are operatively disposed on a vehicle.

10. The system according to claim 9, wherein said vehicle comprises a lift system configured for carrying said vehicle to a near space altitude.

11. The system according to claim 10, wherein said thermal energy converter further comprises at least one heat exchanger arranged for transferring heat from a working fluid to an atmosphere surrounding said vehicle.

12. The system according to claim 9, further comprising a control system programmed to control a position of said vehicle and an orientation of said solar concentrator, so that said solar concentrator is constantly pointed toward a source of solar radiation.

13. The system according to claim 1, wherein said power generation system further comprises an electrolysis system configured for electrolyzing a hydrogen-oxygen mix into a fuel and an oxidizer with added electricity.

14. The system according to claim 1, further comprising a plurality of storage vessels for storing a water, said fuel, and said oxidizer.

15. The system according to claim 14, further comprising a combustor configured for combusting said fuel and said oxidizer to produce a reaction product.

16. The system according to claim 15, further comprising a first heat exchanger configured for cooling said reaction product by transferring heat from said reaction product to an ambient air.

17. The system according to claim 16, further comprising a liquid storage vessel for storing said cooled reaction product.

18. The system according to claim 17, further comprising a fluid transport system for communicating said cooled reaction product from said liquid storage vessel to said electrolysis system.

19. The system according to claim 15, further comprising a heat exchanger configured for transferring heat from said reaction product to a working fluid.

20. The system according to claim 19, wherein said thermal energy converter is configured for converting thermal energy collected by said working fluid to electric power.

21. The system according to claim 20, wherein said thermal energy converter further comprises an engine powered by said working fluid.

22. The system according to claim 21, wherein said thermal energy converter further comprises an electric generator powered by said engine.

23. A method for generating electric power from solar energy, comprising:
exposing to a source of solar radiation a PV/thermal device which includes a photovoltaic array;
cooling said photovoltaic array with a fluid cooling system comprised of a thermal energy collector;
generating electric power with said photovoltaic array and with a thermal energy converter using thermal energy derived from said cooling system; and
supplying said electric power to a power generation system, and generating a fuel and an oxidizer with said power generation system.

24. The method according to claim 23, further comprising storing at least a portion of said fuel and said oxidizer that is generated during daylight hours.

25. The method according to claim 23, further comprising using said fuel and said oxidizer to generate electricity during non-daylight hours.

26. The method according to claim 23, further comprising exposing to a source of solar radiation a solar concentrator formed of an optically reflective material having a curved surface that defines a focal center or a focal line toward which light incident on said curved surface is reflected; and positioning substantially at said focal center or along said focal line said PV/thermal device.

27. The method according to claim 23, further comprising communicating heat from said photovoltaic array to said thermal energy collector through a thermal interface.

28. The method according to claim 27, further comprising heating at least one working fluid contained within a fluid conduit of said thermal energy collector.

29. The method according to claim 28, further comprising powering an engine with said at least one working fluid.

30. The method according to claim 29, further comprising powering an electric generator with said engine.

31. The method according to claim 23, wherein said generating a fuel and an oxidizer step further comprises electrolyzing a hydrogen-oxygen mix.

32. The method according to claim 23, further comprising combusting said fuel and said oxidizer.

33. The method according to claim 32, wherein said combusting step comprises combusting a stoichiometric mixture derived from mixing said fuel and said oxidizer.

34. The method according to claim 32, further comprising communicating heat from a reaction product derived from said combusting step to at least one working fluid.

35. The method according to claim 34, further comprising converting thermal energy collected by said at least one working fluid to electric power.

36. The method according to claim 35, further comprising powering an engine with said at least one working fluid.

37. The method according to claim 36, further comprising powering an electric generator with said engine.

38. The method according to claim 32, further comprising communicating heat from a reaction product derived from said combusting step to an ambient air.

39. The method according to claim 38, further comprising storing said reaction product in a storage vessel.

40. The method according to claim 39, wherein said step of generating said fuel and said oxidizer is further comprised of communicating said reaction product from said storage vessel to said power generation system.

41. The method according to claim 32, further comprising continuously providing to a load, during periods of daylight and non-daylight hours, electric power derived from said PV/thermal device, said thermal energy converter, and said combusting step.

42. The method according to claim 41, further comprising selecting said load to comprise a vehicle.

43. The method according to claim 42, further comprising positioning said vehicle at a near space altitude.

44. The method according to claim 43, further comprising using a temperature differential between a working fluid and a surrounding atmosphere at said near space altitude to power an engine.
